(19) United States
(12) Patent Application Publication
(10) Pub. No.: US 2025/0055243 A1
(43) Pub. Date: Feb. 13, 2025

(54) SOLID LASER AND SOLID LASER SYSTEM

(71) Applicant: SHANGHAI RAYKEEN LASER TECHNOLOGY CO., LTD., Shanghai (CN)

(72) Inventors: Shujie XIA, Shanghai (CN); Jun LI, Shanghai (CN); Jun HUANG, Shanghai (CN); Baojun LEI, Shanghai (CN); Xiaofeng WANG, Shanghai (CN)

(21) Appl. No.: 18/720,651

(22) PCT Filed: Dec. 31, 2021
(86) PCT No.: PCT/CN2021/143849

§ 371 Date: Jun. 16, 2024

(30) Foreign Application Priority Data
Dec. 16, 2021 (CN) 202111541660.7

(51) Int. Cl. H01S 3/042; H01S 3/00; H01S 3/16; H01S 3/23

(52) U.S. Cl. CPC H01S 3/042; H01S 3/0071; H01S 3/1643; H01S 3/23

(57) ABSTRACT

Disclosed are a solid-state laser and a solid-state laser system, including a laser emitting module, a reflection module, a coupling module and a transmission fiber arranged sequentially along a direction of an optical path. The laser emitting module includes at least four laser emitting units integrated in a same integrated chamber, and the laser beams emitted by each laser emitting unit are parallel and independent to each other. The reflection module includes a first reflection unit and a second reflection unit arranged sequentially along the direction of the optical path. The coupling module and the second reflection unit are coaxially arranged and configured to adjust the emission angle of the laser beams, and couple at least four laser beams adjusted by the coupling module into the transmission fiber.

This application is a national stage application under 35 U.S.C. § 371 to International PCT Application PCT/CN2021/143849, entitled “SOLID-STATE LASER AND SOLID-STATE LASER SYSTEM”, filed Dec. 31, 2021, which claims priority to and benefit of China Patent Application No. 202111541660.7, filed Dec. 16, 2021. Both of the above-referenced applications are incorporated into the present application by reference herein in their entirety.

### TECHNICAL FIELD

The present disclosure relates to the field of laser technology, for example, to a solid-state laser and a solid-state laser system.

### BACKGROUND

In the application process of solid-state lasers in related technologies, due to the obvious thermal lens effect of the laser crystal in the resonant cavity when working under high repetition rate conditions, the output power of a single laser crystal cannot be high. For the coupling method of multiple laser light paths, most of them use a motor to switch each laser beam in turn, so that they enter the optical fiber in turn in a certain order. Multiple beams cannot be coupled into an optical fiber strictly at the same time. Some laser designs that do not adopt a motor to switch laser beams use multiple discrete optical elements, and sometimes specially made optical elements, which results in a large number of optical elements and a complex structure. The actual adjustment requires multi-dimensional spatial operations, which increases the difficulty of actual coupling. Multiple laser light paths are difficult to couple into one optical fiber, which increases the production cost.

### SUMMARY

The present disclosure provides a solid-state laser and a solid-state laser system, which can effectively improve the laser output power, and at the same time have a simple structure and are easy to operate.

An embodiment provides a solid-state laser, comprising a laser emitting module, a reflection module, a coupling module and a transmission fiber arranged sequentially along a direction of an optical path, wherein the laser emitting module comprises at least four laser emitting units, and the at least four of laser emitting units are integrated in the same integrated chamber, and the laser beams emitted by each of the laser emitting units are parallel and independent to each other.

The reflection module comprises a first reflection unit and a second reflection unit arranged sequentially along a direction of an optical path; the first reflection unit and the second reflection unit are sequentially located on the propagation path of the laser beams and are configured to sequentially reflect the laser beams to the coupling module.

The coupling module is coaxially arranged with the second reflection unit, and is configured to receive the laser beam reflected by the second reflection unit and couple the laser beams into at least four laser beams to enter the transmission fiber.

An embodiment further provides a solid-state laser system, comprising a packaging shell and said solid-state laser, wherein the solid-state laser is disposed in the packaging shell.

### BRIEF DESCRIPTION OF THE DRAWINGS

FIG. 1 is a schematic diagram of a side view of a solid-state laser according to an embodiment of the present disclosure;

FIG. 2 is a schematic structural diagram of an integrated chamber according to an embodiment of the present disclosure;

FIG. 3 is a schematic structural diagram of a first reflection unit according to an embodiment of the present disclosure;

FIG. 4 is a schematic structural diagram of a first reflection unit according to an embodiment of the present disclosure;

FIG. 5 is a schematic structural diagram of a solid-state laser system according to an embodiment of the present disclosure.

### DETAILED DESCRIPTION

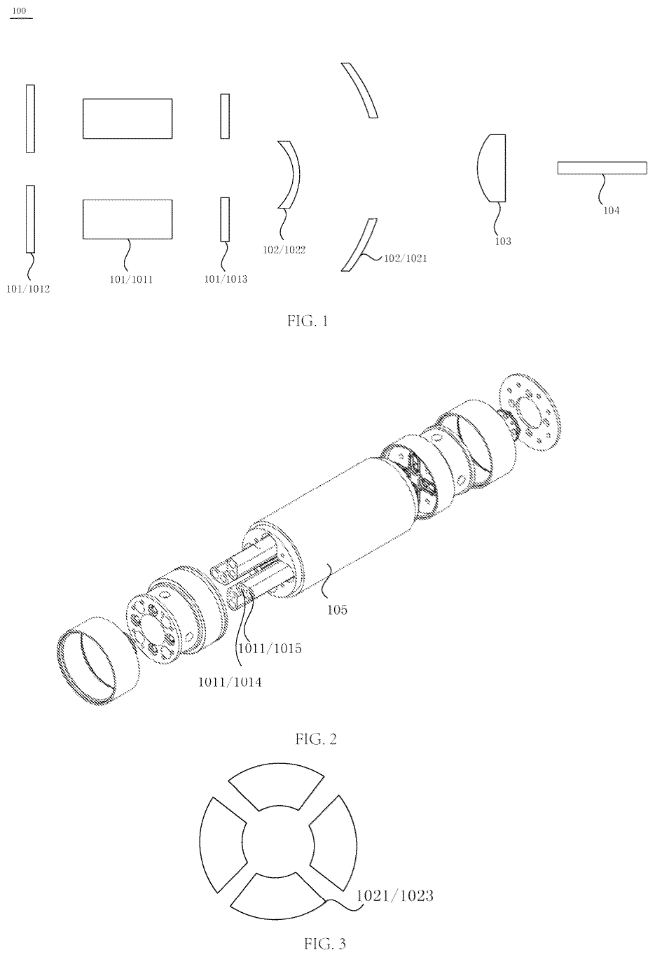

As shown in FIGS. 1 and 2, a solid-state laser 100 comprises a laser emitting module 101, a reflection module 102, a coupling module 103 and a transmission fiber 104 arranged sequentially along a direction of an optical path. The laser emitting module 101 comprises at least four laser emitting units 1011, which are integrated in a same integrated chamber 105, and the laser beams emitted by each laser emitting unit 1011 are parallel and independent to each other. The reflection module 102 comprises a first reflection unit 1021 and a second reflection unit 1022 arranged sequentially along the direction of the optical path. The first reflection unit 1021 and the second reflection unit 1022 are sequentially located on the propagation path of the laser beams, and are configured to sequentially reflect the laser beams to the coupling module 103. The coupling module 103 is coaxially arranged with the second reflection unit 1022, and is configured to couple the received laser beams reflected by the second reflection unit 1022 into at least four laser beams and then make them enter the transmission fiber 104.

The solid-state laser 100 comprises a laser emitting module 101, a reflection module 102, a coupling module 103 and a transmission fiber 104 arranged sequentially along the direction of the optical path. The laser emitting module 101 is configured to emit laser beams. In the laser emitting module 101, a plurality of laser emitting units 1011 which are located in the same integrated chamber 105 and are independent of each other can be provided to reduce the overall volume of the plurality of laser emitting units 1011. The number of the laser emitting units 1011 can be four, six, eight or even more to meet the user's demand for high transmission power. The specific number of the laser emitting units 1011 can be selected according to actual design requirements and is not specifically limited in this embodiment. FIG. 2 shows four laser emitting units 1011 as an example. The laser beams emitted by each laser emitting unit 1011 are parallel and independent to each other. The working states of the four laser emitting units 1011 may comprise controlling one laser emitting unit 1011 to work alone, two laser emitting units 1011 to work simultaneously, three laser emitting units 1011 to work simultaneously, or four laser emitting units 1011 to work simultaneously. During the working process of the two, three or four laser emitting units 1011, they do not affect each other, thereby ensuring the normal operation of each laser emitting unit 1011. The reflection module 102 comprises a first reflection unit 1021 and a second reflection unit 1022 arranged sequentially along the direction of the optical path. The first reflection unit 1021 and the second reflection unit 1022 are sequentially located on the propagation path of the laser beams. The first reflection unit 1021 is configured to receive the laser beams emitted by the laser emitting units 1011 and reflect the same to the second reflection unit 1022. The second reflection unit 1022 is located between the laser emitting units 1011 and the first reflection unit 1021. In this way, the optical path of the laser beams is folded, effectively reducing the spatial distance of the laser beams emitted by the solid-state laser 100. The second reflection unit 1022 receives the laser beams exiting from the first reflection unit 1021, and guides the reflected laser beams to the coupling module 103. To ensure that the laser beams reflected from the second reflection unit 1022 can be received by the coupling module 103, the first reflection unit 1021 may comprise a plurality of reflection units arranged at intervals or in the direction of the laser beams exiting from the second reflection unit 1022. The first reflection unit 1021 is provided with a hollow structure, so that the laser beams exiting from the second reflection unit 1022 can be received by the coupling module 103 through the interval or the hollow structure. The surfaces of the first reflection unit 1021 and the second reflection unit 1022 that are arranged to receive the laser beams may be provided with a coating to achieve reflection of the laser beams. The coupling module 103 receives the laser beams reflected from the second reflection unit 1022 and couples a plurality of laser beams into the same transmission fiber 104 to achieve high-power transmission. The coupling module 103 and the second reflection unit 1022 are coaxially arranged, so that when the user adjusts the optical path, he only needs to adjust the axial distance between the coupling module 103 and the second reflection unit 1022, which is convenient for operation. At the same time, the distance between the laser emitting units 1011 and the first reflection unit 1021 and the distance between the first reflection unit 1021 and the second reflection unit 1022 can be adjusted according to actual design requirements.

In this embodiment, a plurality of laser emitting units are arranged in the same integrated chamber, and the emitted laser beams are parallel and independent to each other, and a reflection module and a coupling module are arranged correspondingly, so that by adjusting the optical path of the laser beams, a plurality of laser beams can be focused to one point to form an ideal light spot. By coupling into the same transmission fiber, high-power transmission is achieved, and there is no need to set up a motor for optical path switching. The overall structure is simple, the integration is high, and the space volume is reduced.

Continuing to refer to FIG. 1, in an embodiment, the second reflection unit 1022 is convex on the side facing the coupling module 103 along the direction of the optical path.

Since the laser beams emitted by the laser emitting unit 1011 have a preset divergence angle, in order to ensure that a plurality of laser beams can be focused to one point through the coupling module 103 later, the second reflection unit 1022 is configured to be convex on the side facing the coupling module 103 along the direction of the optical path. The laser beams reflected by the first reflection units 1021 are received by the second reflection unit 1022. The second reflection unit 1022 will reflect the received laser beams and make the reflected laser beams incident on the coupling module 103 at a preset divergence angle, thereby ensuring the focusing effect of the coupling module 103, and further ensuring that a plurality of laser beams can be coupled into the same transmission fiber 104 to achieve high-power transmission.

FIG. 3 is a structural schematic diagram of the first reflection unit according to this embodiment. In combination with FIGS. 1, 2 and 3, the first reflection unit 1021 comprises at least four first reflection sub-units 1023, the first reflection sub-units 1023 correspond to the laser emitting units 1011 one by one, and the first reflection sub-units 1023 are located on the propagation path of the laser beams emitted by the laser emitting units 1011.

As shown in FIGS. 1 and 3, the exemplary laser emitting module 101 comprises four independently arranged laser emitting units 1011, and the first reflection unit 1021 corresponding to the laser emitting units 1011 comprises four first reflection sub-units 1023, and the first reflection sub-units 1023 respectively receive the laser beams emitted by the laser emitting units 1011 and reflect the laser beams to the second reflection unit 1022. Corresponding to the direction of the laser beams exiting from the second reflection unit 1022, there is a large gap between the four first reflection sub-units 1023, ensuring that the laser beams exiting from the second reflection unit 1022 can be received by the coupling module 103, and the plurality of laser beams are transmitted independently without affecting each other. Compared with the related technology that requires a motor to switch the optical path, the overall structure is simple and easy to install.

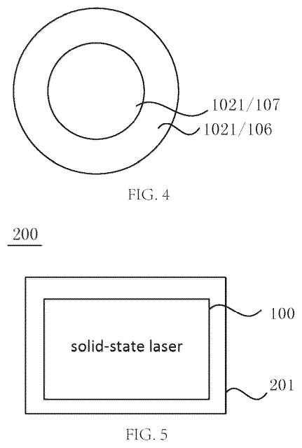

FIG. 4 is a structural schematic diagram of a first reflection unit according to this embodiment. As shown in FIG. 4, the first reflection unit 1021 comprises an annular integrated reflection structure 106 and a hollow structure 107 located in the middle of the annular integrated reflection structure 106. The laser beams reflected by the second reflection unit 1022 are incident on the coupling module 103 through the hollow structure 107.

As shown in FIGS. 1 and 4, the first reflection unit 1021 comprises an annular integrated reflection structure 106 and a hollow structure 107 located in the middle of the annular integrated reflection structure 106. Since the laser beams emitted by each laser emitting unit 1011 are parallel and independent to each other, the laser beams emitted by the laser emitting units 1011 are received by the annular integrated reflection structure 106 and distributed at different positions of the annular integrated reflection structure 106. The annular integrated reflection structure 106 is concave on the side facing the laser emitting module 101, and the received laser beams are reflected at a reflection angle corresponding to the annular integrated reflection structure 106, respectively, and reflected to the second reflection unit 1022. The received laser beams are reflected by the second reflection unit 1022 again, and are incident on the coupling module 103 through the hollow structure 107 of the first reflection unit 1021, which can effectively reduce the spatial volume of the solid-state laser 100 and improve the integration. The first reflection unit 1021 is configured as an annular integrated reflection structure 106. As an integrated design, the number of discrete components is reduced, thereby saving the mechanical structure for fixing optical elements, reducing the spatial volume of the solid-state laser 100, and further reducing the difficulty of the manufacturing process and the difficulty of the user adjusting the optical path.

Continuing to refer to FIG. 1, in an embodiment, the first reflection unit 1021 comprises an arc surface reflection structure, and the first reflection unit 1021 is concave on the side facing the laser emitting module 101 along the direction of the optical path.

As shown in FIG. 1, the first reflection unit 1021 is an arc surface reflection structure, which is concave on the side facing the laser emitting module 101 along the direction of the optical path, and cooperates with the second reflection unit 1022 for reflection to adjust the laser beams, and enables the light reflected by the first reflection unit 1021 to be focused to one point through the coupling module 103, thereby achieving coupling of a plurality of laser beams to the same optical fiber through the coupling module 103. The arc surface angle of the arc reflection structure of the specific first reflection unit 1021 and the arc surface angle of the second reflection unit can be selected according to actual design requirements to ensure that the laser beams reflected by the first reflection unit 1021 and the second reflection unit 1022 can be incident on the coupling module 103 and coupled into the same optical fiber through the coupling module 103. The embodiment of the present invention does not make specific limitations.

Continuing to refer to FIGS. 1 and 2, in an embodiment, along the direction of the optical path, the laser emitting module 101 comprises total reflection mirrors 1012, laser emitting units 1011 and semi-transparent and semi-reflective mirrors 1013 arranged sequentially. A laser emitting unit 1011 comprises a laser crystal 1014 and a pump source 1015. The pump source 1015 is configured to provide pump energy. The laser crystal 1014 is configured to receive the pump energy and be excited to generate a light signal. The total reflection mirrors 1012 and the semi-transparent and semi-reflective mirrors 1013 are configured to resonate and amplify the light signal to form laser beams for emission.

A plurality of independent laser emitting units 1011 are arranged in the same integrated chamber 105, and each laser emitting unit 1011 comprises a laser crystal 1014 and a pump source 1015. The laser crystal 1014 receives the pump energy provided by the pump source 1015 and is excited to generate a light signal. Since the intensity of the light signal generated by the excitation is weak at this time, it cannot be used in practical applications. Therefore, it is necessary to use an optical resonant cavity to amplify the light signal. The total reflection mirrors 1012, the laser emitting units 1011 and the semi-transparent and semi-reflective mirrors 1013 are arranged sequentially, so that the total reflection mirrors 1012 and the semi-transparent and semi-reflective mirrors 1013 are respectively located on a side of the laser emitting units 1011. The light signal emitted by the laser crystal 1014 after being excited is reflected, so that the light signal resonates between the total reflection mirrors 1012 and the semi-transparent and semi-reflective mirrors 1013 to finally form laser beams with high monochromaticity and high directivity, and is emergent from the semi-transparent and semi-reflective mirror 1013.

Continuing to refer to FIG. 1 and FIG. 2, in an embodiment, the pump source 1015 comprises at least one of a xenon-filled flash lamp, a krypton arc lamp, an iodine tungsten lamp, and a semiconductor light emitting diode. The laser crystal 1014 comprises a YAG crystal.

The pump source 1015 can be a xenon-filled flash lamp, a krypton arc lamp, an iodine tungsten lamp or a semiconductor light emitting diode. The pump source 1015 is configured to provide energy to excite the laser crystal 1014, so that the number of particles between the upper and lower energy levels in the laser crystal 1014 is reversed to generate a light signal. The laser crystal 1014 may comprise Cr, Tm, Ho: YAG crystal, Nd: YAG crystal, Er: YAG crystal, Yb: YAG crystal, etc. In this embodiment, Cr, Tm, Ho: YAG crystal is used as an example for explanation. The wavelength of holmium (Ho) laser is 2100 nm, and the corresponding Cr, Tm, Ho: YAG crystal can be excited. Since the laser wavelength of holmium is just at the absorption sub-peak of water, the energy can be efficiently absorbed by the water in human tissue, so it has great application value in medicine, and is mainly used in the fields of stone crushing and tissue cutting.

Continuing to refer to FIG. 1 and FIG. 2, the coupling module 103 comprises a focusing lens.

The coupling module 103 can be a focusing lens, which is configured to focus and converge the divergent laser beams to facilitate subsequent coupling into the transmission fiber 104. In the exemplary FIG. 2, the laser emitting module 101 comprises four laser emitting units 1011, that is, it will emit four laser beams to the coupling module 103. The coupling module 103 receives the four laser beams and, based on the structural characteristics of the coupling module 103 itself, focuses the four divergent laser beams to one point to form a relatively ideal light spot, which is then coupled into the same optical fiber. Coupling can be achieved without the aid of additional optical components, thereby reducing the manufacturing cost and the volume of the solid-state laser 100.

Continuing to refer to FIG. 1 and FIG. 2, in an embodiment, a cooling unit is further disposed in the integrated chamber 105, and the cooling unit is configured to cool and dissipate heat for the laser emitting units 1011.

The solid-state laser 100 will produce a relatively serious thermal effect during operation, and cooling measures are usually required, mainly to cool the laser crystal 1014 and the pump source 1015 in the laser emitting unit 1011. Therefore, a cooling unit is provided in the integrated chamber 105 (not shown in FIG. 2). The cooling unit can use liquid cooling, gas cooling or conduction cooling to achieve cooling effect, ensuring the normal use of the solid-state laser 100 and the protection of equipments.

FIG. 5 is a schematic structural diagram of a solid-state laser system according to this embodiment. As shown in FIG. 5, the solid-state laser system 200 comprises a packaging shell 201 and the solid-state laser 100 described in any one of the above 10 embodiments. The solid-state laser 100 is disposed in the packaging shell 201.

It should be noted that the solid-state laser system has the same or corresponding beneficial effects as the solid-state laser, which will not be described in detail here.

1. A solid-state laser, comprising a laser emitting module, a reflection module, a coupling module and a transmission fiber arranged sequentially along a direction of an optical path,
wherein the laser emitting module comprises at least four laser emitting units, which are integrated in a same integrated chamber, wherein laser beams emitted by each of the laser emitting units are parallel and independent to each other,
wherein the reflection module comprises a first reflection unit and a second reflection unit arranged sequentially along the direction of the optical path, wherein the first reflection unit and the second reflection unit are sequentially disposed on a propagation path of the laser beams, and are configured to sequentially reflect the coupling module,
wherein the coupling module is arranged coaxially with the second reflection unit and is configured to receive the laser beams reflected by the second reflection unit and couple the laser beams into at least four laser beams to enter the transmission fiber.

2. The solid-state laser according to claim 1, wherein the second reflection unit is convex on the side facing the coupling module along the direction of the optical path.

3. The solid-state laser according to claim 1, wherein the first reflection unit comprises at least four first reflection sub-units, wherein the first reflection sub-units correspond to the laser emitting units one by one, and the first reflection sub-units are located on the propagation path of the laser beams emitted by the laser emitting units.

4. The solid-state laser according to claim 1, wherein the first reflection unit comprises an annular integrated reflection structure and a hollow structure located in the middle of the annular integrated reflection structure, wherein the first reflection unit is coaxially arranged with the coupling module, and the laser beams reflected by the second reflection unit are incident on the coupling module through the hollow structure.

5. The solid-state laser according to claim 1, wherein the first reflection unit comprises an arc surface reflection structure, and the first reflection unit is concave on the side facing the laser emitting module along the direction of the optical path.

6. The solid-state laser according to claim 1, wherein along the direction of the optical path, the laser emitting module comprises total reflection mirrors, laser emitting units and semi-transparent and semi-reflective mirrors arranged sequentially,
wherein a laser emitting unit comprise a laser crystal and a pump source, wherein the pump source is configured to provide pump energy, wherein the laser crystal is configured to receive the pump energy and be excited to generate a light signal,
wherein the total reflection mirrors and the semi-transparent and semi-reflective mirrors are configured to resonate and amplify the light signal to form laser beams for emission.

7. The solid-state laser according to claim 6, wherein the pump source comprises at least one of a xenon-filled flash lamp, a krypton arc lamp, an iodine tungsten lamp, and a semiconductor light emitting diode, wherein the laser crystal comprises a YAG crystal.

8. The solid-state laser according to claim 1, wherein the coupling module comprises a focusing lens.

9. The solid-state laser according to claim 1, wherein a cooling unit is further disposed in the integrated chamber, and the cooling unit is configured to cool and dissipate heat for the laser emitting units.

10. A solid-state laser system, comprising a packaging shell and a solid-state laser, wherein the solid-state laser is disposed in the packaging shell,
wherein the solid-state laser comprises a laser emitting module, a reflection module, a coupling module and a transmission fiber arranged sequentially along a direction of an optical path,
wherein the laser emitting module comprises at least four laser emitting units, which are integrated in a same integrated chamber, wherein laser beams emitted by each of the laser emitting units are parallel and independent to each other,
wherein the reflection module comprises a first reflection unit and a second reflection unit arranged sequentially along the direction of the optical path, wherein the first reflection unit and the second reflection unit are sequentially disposed on a propagation path of the laser beams. and are configured to sequentially reflect the laser beams to the coupling module,
wherein the coupling module is arranged coaxially with the second reflection unit and is configured to receive the laser beams reflected by the second reflection unit and couple the laser beams into at least four laser beams to enter the transmission fiber.

11. The solid-state laser system according to claim 10, wherein the second reflection unit is convex on the side facing the coupling module along the direction of the optical path.

12. The solid-state laser system according to claim 10, wherein the first reflection unit comprises at least four first reflection sub-units, wherein the first reflection sub-units correspond to the laser emitting units one by one, and the first reflection sub-units are located on the propagation path of the laser beams emitted by the laser emitting units.

13. The solid-state laser system according to claim 10, wherein the first reflection unit comprises an annular integrated reflection structure and a hollow structure located in the middle of the annular integrated reflection structure, wherein the first reflection unit is coaxially arranged with the coupling module, and the laser beams reflected by the second reflection unit are incident on the coupling module through the hollow structure.

14. The solid-state laser system according to claim 10, wherein the first reflection unit comprises an arc surface reflection structure, and the first reflection unit is concave on the side facing the laser emitting module along the direction of the optical path.

15. The solid-state laser system according to claim 10, wherein along the direction of the optical path, the laser emitting module comprises total reflection mirrors, laser emitting units and semi-transparent and semi-reflective mirrors arranged sequentially,
wherein a laser emitting unit comprise a laser crystal and a pump source, wherein the pump source is configured to provide pump energy, wherein the laser crystal is configured to receive the pump energy and be excited to generate a light signal,
wherein the total reflection mirrors and the semi-transparent and semi-reflective mirrors are configured to resonate and amplify the light signal to form laser beams for emission.

16. The solid-state laser system according to claim 15, wherein the pump source comprises at least one of a xenon-filled flash lamp, a krypton arc lamp, an iodine tungsten lamp, and a semiconductor light emitting diode, wherein the laser crystal comprises a YAG crystal.

17. The solid-state laser system according to claim 10, wherein the coupling module comprises a focusing lens.

18. The solid-state laser system according to claim 10, wherein a cooling unit is further disposed in the integrated chamber, and the cooling unit is configured to cool and dissipate heat for the laser emitting units.
